(19) United States
(12) Patent Application Publication
(10) Pub. No.: US 2026/0330931 A1
(43) Pub. Date: Oct. 22, 2026

(54) METHOD, DEVICE, AND PRODUCT FOR UPGRADING COMPONENT

(71) Applicant: Dell Products L.P., Round Rock, TX (US)

(72) Inventor: Weibing Zhang, Beijing (CN)

(21) Appl. No.: 19/720,290

(22) Filed: Jun. 25, 2026

Related U.S. Application Data
(63) Continuation of application No. 18/417,473, filed on Jan. 19, 2024, now Pat. No. 12,670,767.
Application No. 18/417,473 is a continuation of application No. 17/006,373, filed on Aug. 28, 2020, now Pat. No. 11,922,769.
(60) Provisional application No. 62/894,227, filed on Aug. 30, 2019.
(60) Provisional application No. 62/895,119, filed on Sep. 3, 2019.

(30) Foreign Application Priority Data
Mar. 19, 2026 (CN) 202610339764.6

(51) Int. Cl. G07F 17/32

(52) U.S. Cl. CPC G07F 17/3267; G07F 17/3213; G07F 17/3244

(57) ABSTRACT

A technique to upgrade a component involves acquiring a plurality of version descriptions for a plurality of upgrade versions of a component. Such a technique further involves determining a plurality of deployment scores for the plurality of upgrade versions according to the plurality of version descriptions, wherein each deployment score indicates at least two of version stability, version compatibility, breaking change, and version improvement. Such a technique further involves determining a first upgrade version from the plurality of upgrade versions based on the plurality of deployment scores and a preset policy, wherein the preset policy comprises a limitation for the plurality of deployment scores and a limitation for the plurality of version descriptions. Such a technique further involves upgrading the component by utilizing the first upgrade version.

### CROSS-REFERENCE TO RELATED APPLICATION

This application claims priority to Chinese Patent Application No. CN202610339764.6, on file at the China National Intellectual Property Administration (CNIPA), having a filing date of Mar. 19, 2026, and having “METHOD FOR UPDATING COMPONENT, DEVICE AND PRODUCT” as a title, the contents and teachings of which are herein incorporated by reference in their entirety.

Technical Field

The present disclosure relates to the field of computers, and more particularly, to a method, a device, and a computer program product for upgrading a component.

### BACKGROUND

With the rapid development of software technologies, software systems generally adopt component-based and modular architecture designs. A complete project or software product is usually composed of a plurality of functional components. These components can depend on each other and work coordinately to achieve complex business functions and system operation.

During lifecycle management of a component, in order to adapt to business requirement iteration, operational vulnerability patching, operational performance improvement, or functional scenario expansion, the component will continuously undergo version updates, resulting in a plurality of different upgrade versions. During upgrading of the component, it is usually necessary to evaluate and analyze a plurality of candidate upgrade versions to select the appropriate version to perform the upgrade operation.

### SUMMARY OF THE INVENTION

Embodiments of the present disclosure propose a method, a device, and a computer program product for upgrading a component.

In a first aspect of the embodiments of the present disclosure, a method for upgrading a component is provided. The method includes acquiring a plurality of version descriptions for a plurality of upgrade versions of a component. The method further includes determining a plurality of deployment scores for the plurality of upgrade versions according to the plurality of version descriptions, where each deployment score indicates at least two of version stability, version compatibility, breaking change, and version improvement. The method further includes determining a first upgrade version from the plurality of upgrade versions based on the plurality of deployment scores and a preset policy, where the preset policy includes a limitation for the plurality of deployment scores and a limitation for the plurality of version descriptions. The method further includes upgrading the component by utilizing the first upgrade version.

In a second aspect of the embodiments of the present disclosure, an electronic device is provided. The electronic device includes one or a plurality of processors; and a storage apparatus configured to store one or a plurality of programs, where the one or plurality of programs, when executed by the one or plurality of processors, cause the one or plurality of processors to perform actions including acquiring a plurality of version descriptions for a plurality of upgrade versions of a component. These actions further include determining a plurality of deployment scores for the plurality of upgrade versions according to the plurality of version descriptions, where each deployment score indicates at least two of version stability, version compatibility, breaking change, and version improvement. These actions further include determining a first upgrade version from the plurality of upgrade versions based on the plurality of deployment scores and a preset policy, where the preset policy includes a limitation for the plurality of deployment scores and a limitation for the plurality of version descriptions. These actions further include upgrading the component by utilizing the first upgrade version.

In a third aspect of the embodiments of the present disclosure, a computer program product is provided. The computer program product is tangibly stored on a non-volatile computer-readable medium and includes machine-executable instructions, where the machine-executable instructions, when executed, cause a machine to perform actions including acquiring a plurality of version descriptions for a plurality of upgrade versions of a component. These actions further include determining a plurality of deployment scores for the plurality of upgrade versions according to the plurality of version descriptions, where each deployment score indicates at least two of version stability, version compatibility, breaking change, and version improvement. These actions further include determining a first upgrade version from the plurality of upgrade versions based on the plurality of deployment scores and a preset policy, where the preset policy includes a limitation for the plurality of deployment scores and a limitation for the plurality of version descriptions. These actions further include upgrading the component by utilizing the first upgrade version.

It should be understood that the content described in the Summary of the Invention part is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above and other features, advantages, and aspects of the embodiments of the present disclosure will become more apparent with reference to the accompanying drawings and the following detailed description. In the accompanying drawings, identical or similar reference numerals represent identical or similar elements, in which

FIG. 1 is a schematic diagram of an example environment in which embodiments of the present disclosure can be implemented;

FIG. 2 is a flow chart of a method for upgrading a component according to some embodiments of the present disclosure;

FIG. 3 is a schematic diagram of a process of upgrading a component according to an embodiment of the present disclosure;

FIG. 4 is a schematic diagram of a process of supplementing an information volume;

FIG. 5 is a schematic diagram of a project according to an embodiment of the present disclosure; and

FIG. 6 is a schematic block diagram of an example device that can be used to implement an embodiment of the present disclosure.

### DETAILED DESCRIPTION

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

The embodiments of the present disclosure will be described in more detail below with reference to the accompanying drawings. Although the drawings show some embodiments of the present disclosure, it should be understood that the present disclosure can be implemented in various forms, and should not be explained as being limited to the embodiments stated herein. Instead, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or the same samples. Other explicit and implicit definitions may also be included below.

Currently, when upgrading a component, if the component has a plurality of upgrade versions available, a user typically reads release notes for the upgrade versions and selects one upgrade version based on subjective experience. This method has a low upgrade efficiency and relies on subjective judgment of the user, thus being unstable.

In response, the present disclosure proposes a method for upgrading a component. The method acquires version descriptions related to upgrade versions, determines deployment scores for the upgrade versions according to the version descriptions, uses the scores to represent version stability, version compatibility, breaking change, or version improvement, and based on the deployment scores and a preset policy, selects an upgrade version for upgrading. The method provides an upgrade mechanism that can provide an accurate score for each upgrade version based on an objective version description, while selecting an upgrade version according to the preset policy, thereby improving the accuracy, efficiency, and stability of upgrading the component.

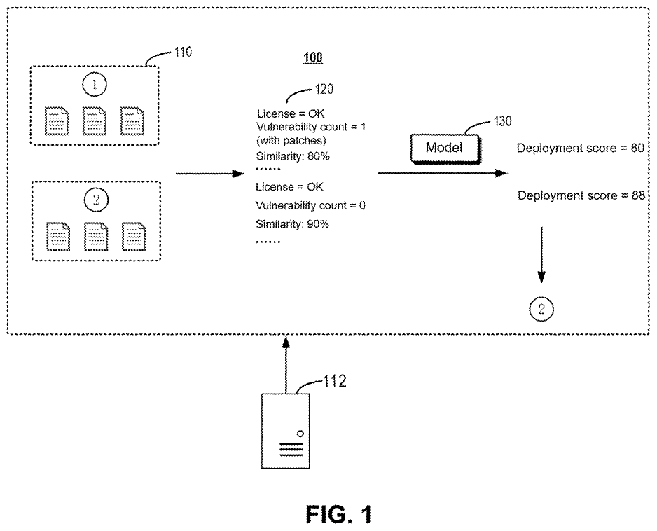

FIG. 1 is a schematic diagram of an example environment 100 in which some embodiments of the present disclosure can be implemented. As shown in FIG. 1, the environment 100 includes a server 112. The method in this embodiment is executed by the server 112. The server 112 can be deployed as a physical server, a virtual server, a distributed server cluster, or the like, has core capabilities such as data storage, logical calculation, resource scheduling, and job management, and can adapt to job scheduling needs of different scales (such as single-machine batch processing and distributed big data jobs). In this embodiment, the server 112 is shown as including a single server, which is merely by way of example. The server 112 may also include any other number of servers. A plurality of servers can collaborate in a cluster to further improve data processing efficiency and meet the needs of large-scale component upgrade scenarios.

In some embodiments, the server 112 may acquire a plurality of version descriptions for a plurality of upgrade versions of a component. As shown in the figure, as an example, the server 112 may acquire three version descriptions of an upgrade version 1. The version descriptions may each include, for example, release notes for the upgrade version, test data, compliance description of a license, vulnerability information, user feedback, or the like. All of this information is objective data that can comprehensively reflect various attributes of the upgrade version, thereby providing a reliable basis for subsequent calculation of deployment scores and avoiding biases in subjective judgment of a user. Similarly, the server 112 may acquire three version descriptions of an upgrade version 2. FIG. 1 shows two upgrade versions, but there can be more upgrade versions, such as an upgrade version 3 and an upgrade version 4. The server can simultaneously acquire relevant descriptions of all available upgrade versions, realize synchronous analysis and comparison for the plurality of versions, and further improve the efficiency and rationality of upgrade selection.

In some embodiments, the server 112 may normalize these version descriptions to obtain features corresponding to the upgrade version 1. For example, a feature set 120 is a normalization result of the upgrade version 1. The feature set 120 may include a plurality of features, each of which represents an attribute of the upgrade version. For example, the upgrade version 1 has a corresponding license and the vulnerability count is 1, where a corresponding patch has been released for the vulnerability. A similarity between code of the upgrade version 1 and code of a current version of the component is 80% (which means that there are significant changes). By quantifying scores, overall performances of different versions can be compared intuitively, thereby preventing the user from selecting an unsuitable version due to subjective judgment errors.

In some embodiments, the server 112 may determine a plurality of deployment scores for the plurality of upgrade versions according to the plurality of version descriptions, where each deployment score indicates at least two of version stability, version compatibility, breaking change, and version improvement. For example, a machine learning model 130 may be deployed in the server 112, which is trained to be capable of determining the deployment score of an input upgrade version according to the input version description of the upgrade version, taking into full account at least two of version stability, version compatibility, breaking change, and version improvement. For example, the deployment score for the upgrade version 1 is 80 points, and the deployment score for the upgrade version 2 is 88 points.

In some embodiments, the server 112 may determine a first upgrade version (for example, the upgrade version 2) from the plurality of upgrade versions based on the plurality of deployment scores and a preset policy, where the preset policy includes a limitation for the plurality of deployment scores and a limitation for the plurality of version descriptions. The preset policy may be, for example, a minimum value of the deployment score, and an upgrade version that is less than the minimum value will be discarded. In some embodiments, the server 112 may select the upgrade version with the highest deployment score from upgrade versions that are higher than the minimum value, and regard it as the first upgrade version. In addition, the preset policy may further include a scenario adaptation limitation, such as prioritizing selection of a version with a low resource occupancy rate for a single-machine deployment scenario and prioritizing selection of a version with a strong compatibility for a distributed deployment scenario, to further adapt to different usage needs and improve the rationality of the upgrade solution.

In some embodiments, the server 112 may utilize the upgrade version 2 to upgrade the component. For example, the server 112 can download and install the upgrade version 2 to upgrade the component. For example, the server 112 may first perform an integrity check and a secondary compatibility check on the upgrade version 2 to ensure that the version is undamaged and fully compatible with the current component environment, thus avoiding failures during the upgrade. After succeeding in the checks, the server 112 can download and install the upgrade version 2 to upgrade the component. The upgrade progress can be monitored in real time during the installation. If any abnormality occurs, a rollback mechanism will be automatically triggered to restore the state before the upgrade, thereby further improving the stability of the upgrade.

The embodiment of the present disclosure constructs a processing environment on the server side that is adapted to multi-scale job scheduling. First, objective version descriptions such as release notes, test data, and compliance descriptions of a plurality of upgrade versions of a component are automatically acquired, and normalized to extract quantifiable version features. Then, deployment scores for the versions are calculated by utilizing a machine learning model based on dimensions such as stability, compatibility, destructiveness, and degree of improvement. Subsequently, the optimal upgrade version is automatically selected according to a preset policy such as a score threshold and scenario adaptation. The integrity and compatibility secondary checks are performed before the upgrade, real-time monitoring is performed during the upgrade, and automatic roll back is performed in case of anomalies, which completely replaces the traditional version selection method that relies on the subjective experience of a user, thereby effectively solving the technical problems of low efficiency and unstable selection in component upgrade, and significantly improving the objectivity, efficiency, and stability of the component upgrade process. Moreover, it can adapt to various job scenarios such as a single-machine scenario and a distributed scenario, thereby ensuring reliable execution in a large-scale component upgrade scenario.

The server 112 may be a cloud server configured to provide foundational cloud computing services such as cloud services, cloud databases, cloud computing, cloud functions, cloud storage, network services, cloud communications, middleware services, domain name services, security services, Content Delivery Networks (CDNs), and big data and artificial intelligence platforms. It should be noted that the method according to the present disclosure may also be applied to a scenario of a non-distributed system, for example, a scenario of a centralized system.

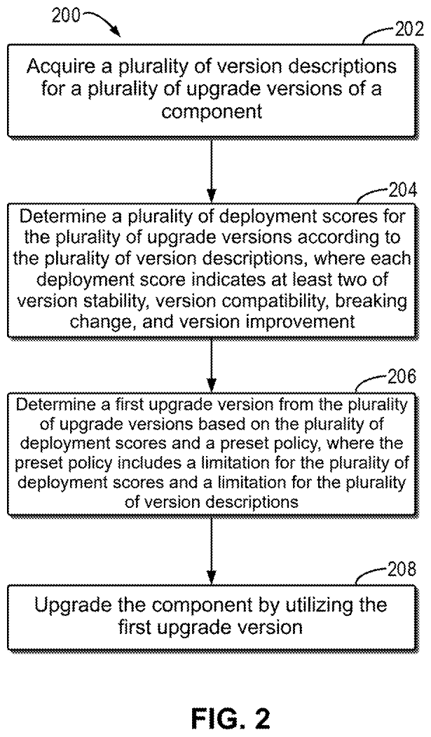

FIG. 2 is a flow chart of a method for upgrading a component according to some embodiments of the present disclosure. As shown in FIG. 2, the flow chart 200 includes a block 202 to a block 206. The method in this embodiment may be implemented by the server 112 shown in FIG. 1. At the block 202, a plurality of version descriptions for a plurality of upgrade versions of a component are acquired. The version description may be various types of information for objectively describing an upgrade version of a component and serve as a primary basis for evaluating the quality of the version. For example, a component to be upgraded is a database component, a current version is 8.0.28, and a database vendor has released three upgrade versions: 8.0.32, 8.0.36, and 8.1.0. The acquired version description may include the following contents. License compliance: Consistency between a license of a statement and a user policy, and an impact of linked third-party software. Vulnerability overview: Number/severity of common vulnerabilities disclosed in the corresponding upgrade version, vulnerability exploitation maturity; and patch version markers. Time/recentness: Official release date, number of days since release, waiting window, and usage time of the deployed version. Stability and breaking change: Deprecated/removed items, backward compatibility notes, and density of unresolved issues. Ecosystem adoption: Packaging/adoption status across different distributions and registries, and project/community coverage. Project local compatibility: Differences in the use of application binary interfaces/application programming interfaces, unit test/integration test/regression test results, and performance deviations. Software bill of materials and dependency diagram: Transitive risk exposure, inventory file differences, and dependency package attribution mapping. Text/natural language processing features: Categorize version release notes (e.g., security fixes, feature deprecations, thread mechanism changes, and the like). Operational risks: Failure/rollback rate, canary release failure rate, and erroneous budget consumption.

At the block 204, a plurality of deployment scores for the plurality of upgrade versions are determined according to the plurality of version descriptions, where each deployment score indicates at least two of version stability, version compatibility, breaking change, and version improvement. The deployment score may be a comprehensive score obtained by quantitatively calculating the version description, while the version stability can indicate whether the version is running stably and can indicate a failure rate. The version compatibility can indicate whether it can be properly adapted to existing systems and dependent components. The breaking change can indicate whether an upgrade will cause existing functions to fail or data to become abnormal. The version improvement can indicate the degree of optimization in performance, functionality, and security of a version. For example, by calculating the deployment scores (e.g., out of 100) using a model/rule, the upgrade version 8.0.32 has high stability and good compatibility, with a deployment score of 86; the upgrade version 8.0.36 has average stability and average compatibility, with a deployment score of 79; and the upgrade version 8.1.0 has high stability but relatively significant breaking change, with a deployment score of 83. In some embodiments, some version descriptions of these version descriptions may relate to the project to which the component belongs. In some embodiments, the deployment score is used to represent at least two of version stability, version compatibility, breaking change, and version improvement, under the condition that the project to which the component belongs is taken into account.

At the block 206, a first upgrade version is determined from the plurality of upgrade versions based on the plurality of deployment scores and a preset policy, where the preset policy includes a limitation for the plurality of deployment scores and a limitation for the plurality of version descriptions. The preset policy may be a pre-defined selection rule, such as a limitation for the deployment score (e.g., the minimum passing score) and a limitation for the version description (e.g., no high-risk vulnerabilities and license compliance). The first upgrade version may be the optimal and most suitable upgrade version for deployment selected according to the policy.

At the block 208, the component is upgraded by utilizing the first upgrade version. Targeting the selected optimal upgrade version, operations such as version download, check, installation, and replacement are performed to complete automated upgrade of the original component.

In the method according to the present disclosure, the method acquires version descriptions related to upgrade versions, determines deployment scores for the upgrade versions according to the version descriptions, uses the scores to represent version stability, version compatibility, breaking change, or version improvement, and based on the deployment scores and a preset policy, selects an upgrade version for upgrading. The method provides an upgrade mechanism that can provide an accurate score for each upgrade version based on an objective version description, while selecting an upgrade version according to the preset policy, thereby improving the accuracy, efficiency, and stability of upgrading the component.

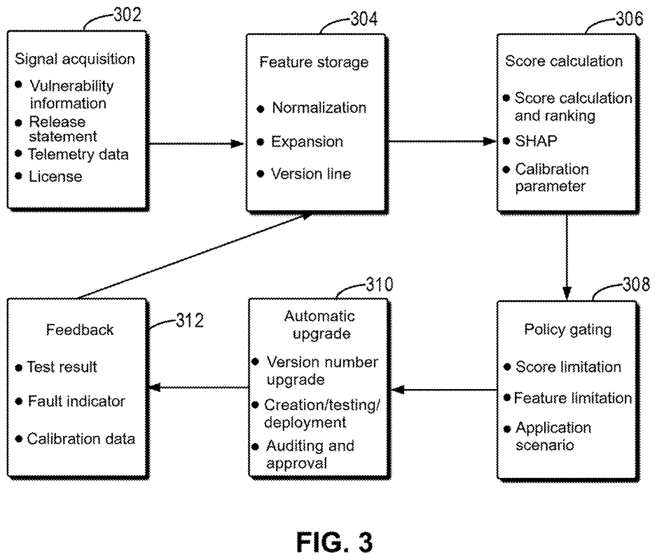

FIG. 3 is a schematic diagram of a process of upgrading a component according to an embodiment of the present disclosure. At a block 302, signals of upgrade versions are acquired, where the signals refer to version descriptions. For example, these signals may carry vulnerability information, release statements, telemetry data, and license compliance information. In some embodiments, the plurality of version descriptions include at least two of the following: licenses, usage records, testing records, compatibility descriptions, and stability descriptions for the plurality of upgrade versions.

At 304, a feature set for the version descriptions is stored, where the feature set includes a plurality of features and is configured to represent the information in the version descriptions. This operation provides structured and reusable basic data for subsequent quantitative calculation of deployment scores, thereby avoiding scoring bias caused by fragmented data and further improving the accuracy of upgrade version selection. In some embodiments, the plurality of upgrade versions include a second upgrade version, and the plurality of version descriptions include a version description for the second upgrade version (i.e., a first version description). The version description includes first release notes, and the version description further includes a version number, a vulnerability count, and a similarity. The similarity indicates a similarity between the second upgrade version and the component, and the server may normalize the version number, the vulnerability count, and the similarity. To eliminate the impact of dimensional differences across different data dimensions (for example, the version number is character-based, the vulnerability count is numerical-based, and the similarity is a percentage) on subsequent scoring, the server may normalize the version number, the vulnerability count, and the similarity. For example, a version number is converted to a value in an interval between 0 and 1 based on the number of iterations, the vulnerability count is mapped to 0 to 1 based on “total vulnerability count/historical maximum vulnerability count” (a smaller value indicates fewer vulnerabilities), and the similarity directly retains the decimal form in an interval between 0 and 1 (e.g., 95% is converted to 0.95), thereby ultimately obtaining and storing feature data in a unified dimension. In some embodiments, the vulnerability count may be represented by an integer representing the quantity, without the need for normalization.

In some embodiments, to facilitate the user in viewing differences between various upgrade versions, the server may draw version lines based on the release time and version number of each version to represent a release order of the versions. In some embodiments, the version descriptions of some of the upgrade versions (such as the release notes) may have missing information or brief content (e.g., only stating “Fix some issues” without specific details), which may lead to insufficient input information for the model and inaccurate scoring. Therefore, the server may supplement the version descriptions and add substantive content before inputting them into the model.

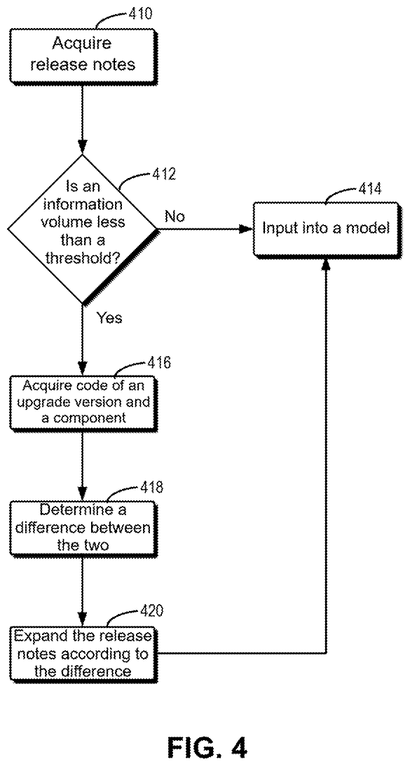

FIG. 4 is a schematic diagram of a process of supplementing an information volume according to an embodiment of the present application. At 410, the server may acquire release notes. The release notes may be provided by a publisher of an upgrade version to explain improvements made in the upgrade version. At 412, the server may detect the information volume in the release notes (i.e., the first release notes) before inputting them into the model. In some embodiments, considering that the release notes of some upgrade versions may have missing information or brief content (e.g., only stating “Fix some issues” without specific details), which may lead to insufficient model input information and inaccurate scoring, the server may detect the information volume in the release notes before inputting them into the model. For example, the server may detect information in 4 aspects: function updates, vulnerability patching, compatibility notes, and breaking changes, where an effective character count excludes meaningless spaces and repetitive phrases.

In some embodiments, if the information volume is less than a threshold (i.e., a first threshold), the process proceeds to 416, where the server may acquire code for a second upgrade version. For example, the server may acquire a complete code package of the second upgrade version through a standardized interface (such as an application programming interface of an official code repository of the component), so as to supplement the version description information at the code level, thereby avoiding scoring deviations due to insufficient information of the release notes and improving the accuracy of the deployment score. At 414, if the information volume is greater than or equal to the threshold, the release notes may be input into the model.

At 418, the server may determine the difference (i.e., the first difference) by comparing the code of the second upgrade version with the component based on the release notes. In some embodiments, the server may use a code comparison tool or an abstract syntax tree analysis method to compare the code of the second upgrade version with code of the current component version in a module by module manner to determine the differences. The differences may include, for example, the number of lines added/deleted in the code, the content of modifications to core functions, changes in the versions of dependency packages, adjustments to configuration files, and the location of code patches corresponding to vulnerability patching.

At 420, the server may expand the release notes based on the differences and proceed to 414 to input the expanded release notes into the model. For example, the above differences are added to the original release notes, and the expanded content is as follows: “1. Fix the memory leak vulnerability caused by hash table expansion in a certain file; 2. Add a connection timeout configuration item; 3. Upgrade the dependency package to 1.1.0, and environment compatibility confirmation is required; 4. The total amount of code changes is about 50 lines, with no breaking changes to core functionality,” to ensure that the subsequent model scoring has sufficient and accurate version description basis.

By performing information volume detection on the release notes of the upgrade version, when the release notes are insufficient in information volume or brief in content, the code of the upgrade version is automatically acquired and compared with the code of the current component to determine the differences between versions. Information expansion is performed on the original release notes based on the code differences. This effectively solves the technical problems of insufficient input information for the scoring model and inaccurate deployment score calculation due to information missing of the release notes, so as to ensure that the information of the version description input into the model is complete, objective, and detailed, thereby significantly improving the accuracy and reliability of deployment score calculation, and providing solid data support for subsequent accurate selection of the optimal upgrade version and stable upgrade of the component.

Returning to FIG. 3, at 306, the server may input the normalization result into the trained model to determine the deployment scores. The model may rank the plurality of upgrade versions according to magnitudes of the deployment scores. At 308, the deployment scores and the feature set may be input into policy gating for selection. In some embodiments, the user may pre-configure a plurality of gates. In some embodiments, the component belongs to a project, and the preset policy includes a first policy, a second policy, and a third policy. The first policy indicates a minimum threshold for a plurality of deployment scores to filter upgrade versions with too low scores or with stability risks. In some embodiments, the second policy indicates requirements for the plurality of version descriptions (or requirements for features), such as hard requirements for limiting the compliance and completeness of the version descriptions, for example, requiring that the versions have no high-risk vulnerabilities, comply with licenses, meet compatibility standards, and the like. In some embodiments, the third policy instructs score adjustments based on a use scenario of the project, such as dynamically adjusting weights of scoring dimensions for different scenarios, such as development environment, testing environment, online environment, single-machine deployment, and distributed cluster deployment. In some embodiments, a deployment score may include a plurality of sub-scores, and these sub-scores represent scores of an upgrade version in different dimensions, such as stability, security, and efficiency.

In some embodiments, a first set including at least one deployment score may be determined from the plurality of deployment scores based on the first policy and the second policy, where versions in the first set are all candidate upgrade versions that meet basic admission criteria. In some embodiments, the first set may be updated based on the third policy. For example, if the upgrade is performed for a component of a project in an online environment, a sub-score related to version stability is increased; if the upgrade is performed for a component of a project in a development environment, a sub-score related to version improvement is increased, thus obtaining an updated first set adapted to the current scenario.

In some embodiments, the first upgrade version may be determined based on the updated first set. In some embodiments, based on the first set adjusted after scenario adaptation, ranking is performed according to modified deployment scores to initially determine the first upgrade version with the optimal overall score.

In some embodiments, during determination of the first upgrade version, a loss set and a gain set may be determined based on the updated first set, where a loss in the loss set represents a loss caused by a failed deployment of a corresponding version, and a gain in the gain set represents a gain brought by a successful deployment of a corresponding version. For example, losses in the loss set are used to represent the degrees of negative impacts caused by failed deployments of the corresponding versions, for example, potential losses such as business interruption risk, system anomaly, data corruption, and functional failure. Gains in the gain set are used to represent the improvement effects brought by successful deployments of the corresponding versions, for example, actual benefits such as performance optimization, vulnerability patching, functional enhancement, and reduced resource consumption.

In some embodiments, the first upgrade version may be determined based on the loss set and the gain set. For example, by comprehensively considering the potential losses in the loss set and the expected gains in the gain set, and by weighing risks and benefits, the version with the smallest loss, the largest gain, and the best overall cost-effectiveness is selected from the candidate versions as the first upgrade version, thereby further improving the security, reliability, and business adaptability of the component upgrade. For example, if the upgrade version 1 has a deployment score of 80, a loss of 50,000, and a gain of 100,000, an expected value of the upgrade version 1 may be (1−80/100)×50000−80/100×100000=−30000. A lower expected value indicates a lower consumption of the upgrade version and more advantages thereof. In some embodiments, a similar calculation may be performed on each upgrade version to select the upgrade version with the smallest expected value as the first upgrade version.

At 310, after the first upgrade version is determined, the component may be upgraded. The server may synchronously upgrade the version number of the component, create an upgrade environment and deploy the first upgrade version, and test the upgraded component. In some embodiments, application of the upgrade version requires auditing and approval.

At 312, feedback is generated according to test or usage data of the component. The feedback includes, for example, a test result, a fault indicator detected when the component fails during use, and calibration data from calibration of the component during use of the component. These types of feedback may be normalized to form features in the feature set and used to adjust parameters of the model, thereby improving the accuracy of the model in determining deployment scores.

In some embodiments, the component includes a first application programming interface, and the server may acquire a plurality of second application programming interfaces corresponding to the plurality of upgrade versions. The first application programming interface may be an application programming interface that calls the component, and the second application programming interface may be an application programming interface that calls a corresponding upgrade version.

In some embodiments, the server may determine a second difference based on the first application programming interface and the plurality of second application programming interfaces. The second difference includes, for example, addition or deprecation of application programming interfaces, changes in interface names and parameter types, adjustments to the number of input parameters and constraints, modifications to a return value data structure, compatibility breaking changes, and differences in calling permissions and dependent environments. These differences directly reflect the degrees of differences in call adaptability between the upgrade version and the current component, and are the key basis for evaluating version compatibility and breaking changes. Furthermore, if the second difference reflects a significant difference, it means that after the component is upgraded, another component in the involved project that calls the component needs to be adjusted synchronously.

In some embodiments, the server may generate a plurality of supplementary association patterns based on the second difference, to be added to the plurality of version descriptions. By supplementing the associated information at the interface level, the subsequent calculation of deployment scores may more comprehensively consider interface compatibility risks and breaking changes, thereby further improving the accuracy and reference value of deployment scores. At the same time, it provides an objective basis for policy gating selection and determination of the optimal upgrade version at the interface compatibility level, thereby avoiding problems such as call failure and functional abnormalities after the component upgrade due to incompatibility of application programming interfaces.

In some embodiments, the plurality of deployment scores are determined by a model, and the model is trained by the following operations: obtaining a plurality of third version descriptions for a plurality of upgrade versions of a second component as a plurality of samples; acquiring a plurality of labels for the plurality of third version descriptions; using the model to determine a plurality of predictions according to the plurality of third version descriptions; and updating the model according to the plurality of predictions and the plurality of labels. The model configured to calculate deployment scores corresponding to a plurality of upgrade versions is a quantitative scoring model trained through supervised learning. Through a standardized training process, the model can accurately learn mapping relationships between version descriptions and deployment scores, thereby ensuring objectivity, accuracy, and generalization ability of deployment score calculation, and adapting to scoring requirements of different types of components and different iteration stages.

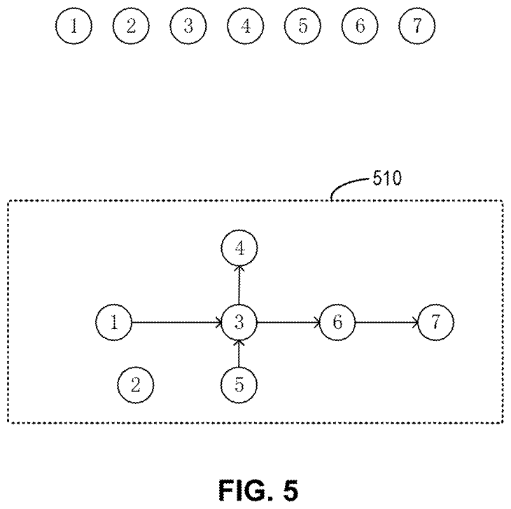

FIG. 5 is a schematic diagram of a project according to an embodiment of the present disclosure. In some embodiments, a component 3 is a part of a project, and the project further includes a first component, and the component calls the first component. For example, the project includes 7 components, where the component 3 may be a component configured for upgrade, and the first component may be a component 6. In this project, the components may have calling relationships. For example, a component 1 calls the component 3, a component 5 calls the component 3, the component 3 calls a component 4 and the component 6, the component 6 calls a component 7, and a component 2 does not call any of other components. In some embodiments, the project further includes a second component, and the second component may be the component 7. The server may generate a graph 510 according to the calling relationships among various components in the project.

In some embodiments, a second version description for a version used by the component 6 is acquired. For example, the second version description includes stability data, interface call specification, dependency constraint, vulnerability information, and the like of the current version, which may be used as reference information for evaluating the version to be upgraded. In some embodiments, a first deployment score for the second upgrade version is determined based on the first version description and the second version description. In other words, during calculation of the deployment score, the version descriptions of other components with calling relationships may be considered simultaneously, thus calculating a more accurate deployment score.

In some embodiments, an impact of the first upgrade version on the component 6 and the component 7 is detected. This impact may include changes in interface compatibility, risks of abnormal function calls, and propagation of breaking changes, thereby detecting whether there are problems such as call failures, data anomalies, or functionality malfunctions after the upgrade. In some embodiments, the component 6 and the component 7 are upgraded based on the impact. While ensuring the overall stable operation of the project, reliable upgrades of the component 6 and the component 7 are completed to avoid the failure of the entire project due to the upgrade of a single component.

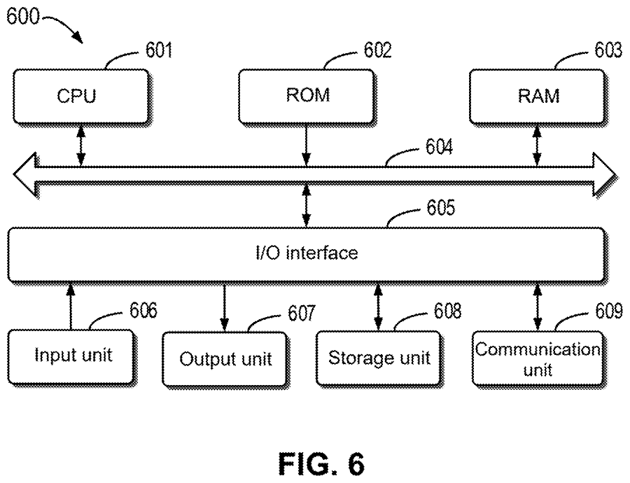

FIG. 6 is a schematic block diagram of an example device 600 that can be configured to implement embodiments of the present disclosure. As shown in the figure, the device 600 includes a computing unit 601 that can perform various appropriate actions and processing according to computer program instructions stored in a read-only memory (ROM) 602 or computer program instructions loaded from a storage unit 608 to a random access memory (RAM) 603. Various programs and data required for the operation of the device 600 may also be stored in the RAM 603. The computing unit 601, the ROM 602, and the RAM 603 are connected to each other through a bus 604. An input/output (I/O) interface 605 is also connected to the bus 604.

A plurality of components in the device 600 are connected to the I/O interface 605, including: an input unit 606, such as a keyboard and a mouse; an output unit 607, such as various types of displays and speakers; the storage unit 608, such as a magnetic disk and an optical disc; and a communication unit 609, such as a network card, a modem, and a wireless communication transceiver. The communication unit 609 allows the device 600 to exchange information/data with other devices via a computer network, such as the Internet, and/or various telecommunication networks.

The computing unit 601 may be various general-purpose and/or special-purpose processing components with processing and computing power. Some examples of the computing unit 601 include, but are not limited to, a central processing unit (CPU), a graphics processing unit (GPU), various specialized artificial intelligence (AI) computing chips, various computing units for running machine learning model algorithms, a digital signal processor (DSP), and any appropriate processor, controller, microcontroller, and the like. The computing unit 601 performs various methods and processing described above, such as the method 200. For example, in some embodiments, the method 200 may be implemented as a computer software program that is tangibly included in a machine-readable medium, such as the storage unit 608. In some embodiments, part of or all the computer program can be loaded and/or installed onto the device 600 via the ROM 602 and/or the communication unit 609. When the computer program is loaded to the RAM 603 and executed by the computing unit 601, one or more steps of the method 200 described above can be performed. Alternatively, in other embodiments, the computing unit 601 can be configured to perform the method 200 in any other suitable manners (e.g., by means of firmware).

The functions described hereinabove can be performed at least in part by one or more hardware logic components. For example, non-restrictively, demonstration types of hardware logic components that can be used include Field Programmable Gate Arrays (FPGAs), Application Specific Integrated Circuits (ASICs), Application Specific Standard Products (ASSPs), Systems On Chip (SOCs), Load Programmable Logic Devices (CPLDs), etc.

Program codes for implementing the method of the present disclosure may be written by using one programming language or any combination of multiple programming languages. The program codes may be provided to a processor or controller of a general purpose computer, a special purpose computer, or another programmable data processing apparatus, such that the program codes, when executed by the processor or controller, cause the functions/operations specified in the flow charts and/or block diagrams to be implemented. The program codes may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, it should be understood that such operations are required to be performed in the particular order shown or in a sequential order, or that all illustrated operations should be performed to achieve desirable results. In certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. In contrast, various features that are described in the context of a single implementation may also be implemented in multiple implementations separately or in any suitable sub-combination.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, wherein the programming languages include object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions to implement various aspects of the present disclosure.

Various aspects of the present disclosure are described herein with reference to flow charts and/or block diagrams of the method, the apparatus (system), and the computer program product according to the embodiments of the present disclosure. It should be understood that each block of the flow charts and/or the block diagrams and combinations of blocks in the flow charts and/or the block diagrams may be implemented by the computer-readable program instructions.

These computer-readable program instructions may be provided to a processing unit of a general-purpose computer, a special-purpose computer, or other programmable data processing apparatuses to produce a machine, such that these instructions, when executed by the processing unit of the computer or other programmable data processing apparatuses, produce means (e.g., specialized circuitry) for implementing the functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored thereon includes an article of manufacture that includes instructions that implement various aspects of the functions/actions specified in one or more blocks in the flow charts and/or block diagrams.

The computer-readable program instructions may also be loaded onto a computer, other programmable data processing apparatuses, or other devices, such that a series of operations or steps are performed on the computer, other programmable data processing apparatuses, or other devices to produce a computer-implemented process, such that the instructions executed on the computer, other programmable data processing apparatuses, or other devices implement the functions/actions specified in one or more blocks in the flow charts and/or block diagrams.

The flow charts and block diagrams in the drawings illustrate the architectures, functions, and operations of possible implementations of the systems, methods, and computer program products according to a plurality of embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, the functions noted in the blocks may also occur in an order different from that noted in the accompanying drawings. For example, two successive blocks may actually be executed in parallel substantially, and sometimes they may also be executed in a reverse order, which depends on the functions involved. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

The embodiments of the present disclosure have been described above. The above description is illustrative rather than exhaustive, and is not limited to the disclosed various embodiments. Numerous modifications and alterations are apparent to persons of ordinary skill in the art without departing from the scope and spirit of the illustrated embodiments. The selection of terms used herein is intended to best explain the principles and practical applications of the various embodiments or the improvements to technologies on the market, or to enable other persons of ordinary skill in the art to understand the embodiments disclosed here.

What is claimed is:

1. A method for upgrading a component, comprising:
acquiring a plurality of version descriptions for a plurality of upgrade versions of a component;
determining a plurality of deployment scores for the plurality of upgrade versions according to the plurality of version descriptions, wherein each deployment score indicates at least two of version stability, version compatibility, breaking change, and version improvement;
determining a first upgrade version from the plurality of upgrade versions based on the plurality of deployment scores and a preset policy, wherein the preset policy comprises a limitation for the plurality of deployment scores and a limitation for the plurality of version descriptions; and
upgrading the component by utilizing the first upgrade version.

2. The method according to claim 1, wherein the plurality of upgrade versions comprise a second upgrade version, the plurality of version descriptions comprise a first version description for the second upgrade version, the first version description comprises first release notes, and determining the plurality of deployment scores for the plurality of upgrade versions according to the plurality of version descriptions comprises:
detecting an information volume of the first release notes;
in response to the information volume being less than a first threshold, acquiring code of the second upgrade version;
determining a first difference by comparing the code of the second upgrade version with the component based on the first release notes; and
expanding the first release notes according to the first difference.

3. The method according to claim 2, wherein the first version description further comprises a version number, a vulnerability count, and a similarity, the similarity indicating a similarity between the second upgrade version and the component, and the method further comprises:
normalizing the version number, the vulnerability count, and the similarity.

4. The method according to claim 2, wherein the component is a part of a project, the project further comprises a first component, the component calls the first component, and determining the plurality of deployment scores for the plurality of upgrade versions according to the plurality of version descriptions comprises:
acquiring a second version description for a version used by the first component; and
determining a first deployment score for the second upgrade version based on the first version description and the second version description.

5. The method according to claim 4, wherein the project further comprises a second component, the first component calls the second component, and the method further comprises:
detecting an impact of the first upgrade version on the first component and the second component; and
upgrading the first component and the second component based on the impact.

6. The method according to claim 1, wherein the component belongs to a project, the preset policy comprises a first policy, a second policy, and a third policy, the first policy indicating a minimum threshold for the plurality of deployment scores, the second policy indicating a requirement for the plurality of version descriptions, the third policy indicating a score adjustment based on a use scenario of the project, and determining the first upgrade version from the plurality of upgrade versions based on the plurality of deployment scores and the preset policy comprises:
determining, from the plurality of deployment scores, a first set comprising at least one deployment score based on the first policy and the second policy;
updating the first set based on the third policy; and
determining the first upgrade version based on the updated first set.

7. The method according to claim 6, wherein determining the first upgrade version based on the updated first set comprises:
determining a loss set and a gain set based on the updated first set, wherein a loss in the loss set represents a loss caused by a failed deployment of a corresponding version, and a gain in the gain set represents a gain brought by a successful deployment of a corresponding version; and
determining the first upgrade version according to the loss set and the gain set.

8. The method according to claim 1, wherein the component comprises a first application programming interface, and the method further comprises:
acquiring a plurality of second application programming interfaces corresponding to the plurality of upgrade versions;
determining a second difference based on the first application programming interface and the plurality of second application programming interfaces; and
generating, according to the second difference, a plurality of supplementary association patterns to be added to the plurality of version descriptions.

9. The method according to claim 1, wherein the plurality of deployment scores are determined by a model, and the model is trained by the following operations:
acquiring a plurality of third version descriptions for a plurality of upgrade versions of the second component, as a plurality of samples;
acquiring a plurality of labels for the plurality of third version descriptions;
determining a plurality of predictions using the model according to the plurality of third version descriptions; and
updating the model according to the plurality of predictions and the plurality of labels.

10. The method according to claim 1, wherein the plurality of version descriptions comprise at least two of licenses, usage records, test records, compatibility descriptions, and stability descriptions of the plurality of upgrade versions.

11. An electronic device, comprising:
at least one processor; and
memory coupled to the at least one processor and having instructions stored therein, wherein the instructions, when executed by the at least one processor, cause the electronic device to perform a method of:
acquiring a plurality of version descriptions for a plurality of upgrade versions of a component;
determining a plurality of deployment scores for the plurality of upgrade versions according to the plurality of version descriptions, wherein each deployment score indicates at least two of version stability, version compatibility, breaking change, and version improvement;
determining a first upgrade version from the plurality of upgrade versions based on the plurality of deployment scores and a preset policy, wherein the preset policy comprises a limitation for the plurality of deployment scores and a limitation for the plurality of version descriptions; and
upgrading the component by utilizing the first upgrade version.

12. The electronic device according to claim 11, wherein the plurality of upgrade versions comprise a second upgrade version, the plurality of version descriptions comprise a first version description for the second upgrade version, the first version description comprises first release notes, and
wherein determining the plurality of deployment scores for the plurality of upgrade versions according to the plurality of version descriptions includes:
detecting an information volume of the first release notes;
in response to the information volume being less than a first threshold, acquiring code of the second upgrade version;
determining a first difference by comparing the code of the second upgrade version with the component based on the first release notes; and
expanding the first release notes according to the first difference.

13. The electronic device according to claim 12, wherein the first version description further comprises a version number, a vulnerability count, and a similarity, the similarity indicating a similarity between the second upgrade version and the component, and
wherein the method further includes:
normalizing the version number, the vulnerability count, and the similarity.

14. The electronic device according to claim 12, wherein the component is a part of a project, the project further comprises a first component, the component calls the first component, and
wherein determining the plurality of deployment scores for the plurality of upgrade versions according to the plurality of version descriptions includes:
acquiring a second version description for a version used by the first component; and
determining a first deployment score for the second upgrade version based on the first version description and the second version description.

15. The electronic device according to claim 14, wherein the project further comprises a second component, the first component calls the second component, and
wherein the method further includes:
detecting an impact of the first upgrade version on the first component and the second component; and
upgrading the first component and the second component based on the impact.

16. The electronic device according to claim 11, wherein the component belongs to a project, the preset policy comprises a first policy, a second policy, and a third policy, the first policy indicating a minimum threshold for the plurality of deployment scores, the second policy indicating a requirement for the plurality of version descriptions, the third policy indicating a score adjustment based on a use scenario of the project, and
wherein determining the first upgrade version from the plurality of upgrade versions based on the plurality of deployment scores and the preset policy includes:
determining, from the plurality of deployment scores, a first set comprising at least one deployment score based on the first policy and the second policy;
updating the first set based on the third policy; and
determining the first upgrade version based on the updated first set.

17. The electronic device according to claim 16, wherein determining the first upgrade version based on the updated first set includes:
determining a loss set and a gain set based on the updated first set, wherein a loss in the loss set represents a loss caused by a failed deployment of a corresponding version, and a gain in the gain set represents a gain brought by a successful deployment of a corresponding version; and
determining the first upgrade version according to the loss set and the gain set.

18. The electronic device according to claim 11, wherein the component comprises a first application programming interface, and
wherein the method further includes:
acquiring a plurality of second application programming interfaces corresponding to the plurality of upgrade versions;
determining a second difference based on the first application programming interface and the plurality of second application programming interfaces; and
generating, according to the second difference, a plurality of supplementary association patterns to be added to the plurality of version descriptions.

19. The electronic device according to claim 11, wherein the plurality of deployment scores are determined by a model, and the model is trained by the following operations:
acquiring a plurality of third version descriptions for a plurality of upgrade versions of the second component, as a plurality of samples;
acquiring a plurality of labels for the plurality of third version descriptions;
determining a plurality of predictions using the model according to the plurality of third version descriptions; and
updating the model according to the plurality of predictions and the plurality of labels.

20. A computer program product having a non-transitory computer readable medium which stores a set of instructions to upgrade a component; the set of instructions, when carried out by computerized circuitry, causing the computerized circuitry to perform a method of:
acquiring a plurality of version descriptions for a plurality of upgrade versions of a component;
determining a plurality of deployment scores for the plurality of upgrade versions according to the plurality of version descriptions, wherein each deployment score indicates at least two of version stability, version compatibility, breaking change, and version improvement;
determining a first upgrade version from the plurality of upgrade versions based on the plurality of deployment scores and a preset policy, wherein the preset policy comprises a limitation for the plurality of deployment scores and a limitation for the plurality of version descriptions; and
upgrading the component by utilizing the first upgrade version.
